(19) United States
(12) Patent Application Publication
(10) Pub. No.: US 2009/0118652 A1
(43) Pub. Date: May 7, 2009

(54) NECK MASSAGING DEVICE

(76) Inventor: VITO JAMES CARLUCCI, STRATFORD, CT (US)

Correspondence Address: Lawrence Cruz;Conair Corporation, One Cummings Point Road, STAMFORD, CT, 06902, US

(21) Appl. No.: 12/245,254

(22) Filed: Oct. 3, 2008

Related U.S. Application Data
(60) Provisional application No. 60/997,489, filed on Oct. 3, 2007.

(51) Int. Cl. A61H 7/00; A61H 19/00

(52) U.S. Cl. 601/134; 601/101

(57) ABSTRACT

A portable neck massaging appliance 1 has an electric motor 13 driving a mechanical drive gear system 14, 15, 16, 17, 18 associated with the motor for rotationally driving two massage nodes 11, 12. Each massage node 11, 12 presses against a user's neck when the appliance 1 is worn around the neck and in contact with the back of the neck, delivering massage forces to the user's neck.

### CROSS-REFERENCE TO RELATED APPLICATIONS

This application relates to and claims priority from U.S. Provisional Application No. 60/997,489 filed 3 Oct. 2007.

### BACKGROUND OF THE INVENTION

The present invention relates to personal care appliances and, more particularly, to portable neck massaging appliances.

### Description of Related Art

Various neck massaging appliances exist in a variety of forms. For example, known neck massaging appliances comprise an elongated, flexible pad or cushion containing one or more vibration elements comprised of an electric motor and a rotating eccentric weight to create vibrations. The pad or cushion may be U-shaped to conveniently be positioned partially around a user's neck.

Other massaging devices, though not specifically configured for or intended to be use for the neck, comprise large pads that are placed on seatbacks of chairs and that have one or more “shiatsu” style massage assemblies. Such assemblies include one or more rotatable, protruding massage members that may have symmetrical shapes or asymmetric shapes to cause a desired massaging effect.

No know appliances exist that provide a shiatsu type massage assembly in a small, portable sized and shaped massage appliance that is suitable to be used around a user's neck.

### OBJECT OF THE PRESENT INVENTION

It is an object of the present invention to provide a portable massaging appliance, suitably sized and shaped for use around a user's neck, that has electrically-powered, motor-driven shiatsu style rotatable massage nodes. It is a further object to provide such a massaging appliance wherein the massage nodes are flexibly mounted to prevent discomfort and injury to the user.

These an other objects are achieved by the present invention disclosed herein.

### SUMMARY OF THE INVENTION

According to the present invention, a portable neck massaging appliance has an electric motor that is battery-operated or that can be attached to an external electrical power source via an electrical cord. The appliance has a mechanical drive system associated with the motor for rotationally driving two massage nodes. Each massage node is mounted to a drive shaft via a spring that is rigid enough to transfer forces but that yields at a predetermined resistance force to prevent discomfort to the user.

### BRIEF DESCRIPTION OF THE DRAWINGS

FIG. 1 is a rear view of a first embodiment of the present invention.

FIG. 2 is a top view of a first embodiment of the present invention.

FIG. 3 is a side view of a first embodiment of the present invention.

FIG. 4 is a top view of an electrical cord and adapter used with a first embodiment of the present invention.

FIG. 5 is a side view of an electrical cord and adapter used with a first embodiment of the present invention.

FIG. 6 is a bottom, partially internal view of a first embodiment of the present invention.

FIG. 7 is a side, partially internal view of a first embodiment of the present invention.

FIG. 8 is an exploded view of the motor and massage node assembly according to a first embodiment of the present invention.

FIG. 9 is an exploded view of the motor and massage node assembly according to a second embodiment of the present invention.

### DESCRIPTION OF THE PREFERRED EMBODIMENTS OF THE PRESENT INVENTION

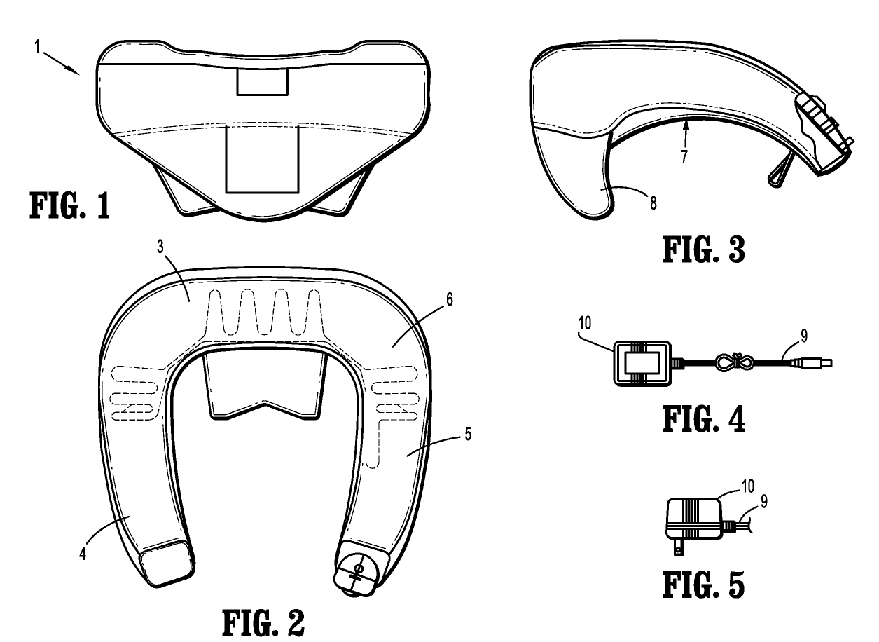

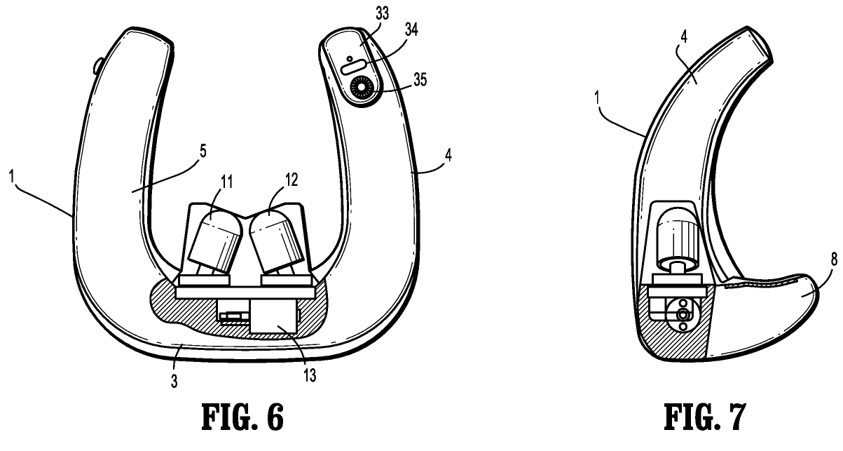

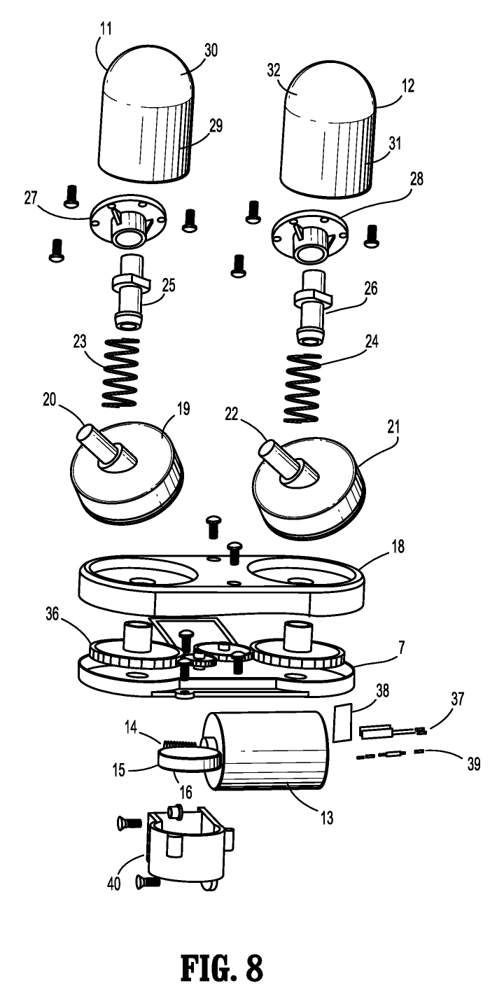

Referring to FIGS. 1-8, a neck massaging appliance 1 according to a first embodiment of the present invention comprises: a generally U-shaped cushion 2 comprising a central portion 3, a first arm 4, a second arm 5, a top surface 6, and a bottom surface 7; a downwardly extending massage section 8; an electrical cord 9 and adapter plug 10; a first massage node 11; a second massage node 12; an electric motor 13; a worm gear 14; a spur gear 15 surrounded by a cover 16; a gear assembly comprising a lower housing 17 and an upper housing 18; a first rotatable node base 19 having a stem 20; a second rotatable node base 21 having a stem 22; a first spring 23; a second spring 24; a first connector pin 25; a second connector pin 26; a first plate 27; and a second plate 28. The first massage node 11 comprises a cylindrical body section 29 and a dome section 30. The second massage node 12 comprises a cylindrical body section 31 and a dome section 32.

In operation, a user places the appliance 1 around his or her neck so that the central portion 3 is in contact with the back of the user's neck. The first and second arms 4, 5 rest on the shoulders pointing toward the front. The user activates the power with the on/off button 34 on the switchplate 33 and uses the control knob 35 to control hi/low/off for massaging function. The switch 34, rotary knob 35 and electronic circuitry for controlling the motor 13 are of a type generally known.

When the motor 13 is activated, its output shaft causes the worm gear 14 to rotate and drive the spur gear 15 which, in turn, drives the gear assembly 36. The gear assembly 36 is of a type generally known to those skilled in the art to convert output from the electric motor 13 into rotational motion being delivered to two output shafts, in this case being the rotating bases 19, 21 and their respective stems 20, 22.

The respective springs 23, 24 are each positioned over one of the respective stems 20, 22. The connector pins 25, 26 and the respective plates 27, 28 connect the nodes 11, 12, respectively, to one of the stems 20, 22. The springs 23, 24 permit some axial play between the stems 20, 22 and the nodes 11, 12.

As the user selects one of the speeds hi or low using the knob 35, the motor 13 causes the nodes 11, 12 to be driven rotationally. Contact is made with the user's neck by the extending section 8, in which the nodes 11, 12 are located and covered with a cloth or fabric that covers the entire appliance 1. The nodes 11, 12 impart massaging rotational and axial forces to the neck of the user. The springs 23, 24 flex if axial force sufficient to overcome them is applied, thus preventing discomfort or pain to the user. A thermostat 37, kapiton paper 38, and thermo cutoff switch 39 comprise a safety circuit. A mounting bracket 40 supports the motor and assembly.

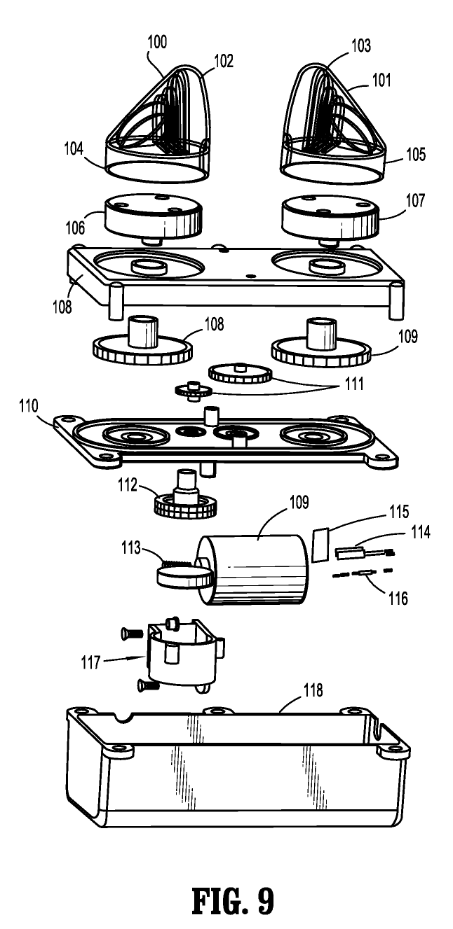

A second embodiment of the present invention is shown in FIG. 9. The second embodiment is essentially the same as the first embodiment described above except for the nodes and drive assembly, as described below and shown in FIG. 9. The massage nodes 100, 101 have an eccentrically aligned, conical head, each respective head being shown as 102, 103 in FIG. 9. The nodes 100, 101 each have a respective cylindrical base section 104, 105. A first drive plate 106 and a second drive plate 107 are driven by respective output gears 108, 109. The nodes 100, 101 are mounted to the drive plates 106, 107 through the top plate 108 and, therefore, driven by the motor 109. A gear plate 110 and driven gears 111 comprise the intermediate gear assembly. A spur gear 112 driven by a worm gear 113 delivers output from the motor 109. A thermostat 114, kapiton paper 115, and thermo cutoff switch 116 comprise a safety circuit. A mounting bracket 117 and bottom enclosure 118 support the motor and assembly.

While the preferred embodiment of the present invention has been disclosed herein, it is understood that various modification can be made without departing from the scope of the presently claimed invention.

What is claimed is:

1. A neck massaging appliance for making contact with and applying massaging forces to a person's neck, said appliance comprising:
a generally U-shaped body having a middle section, a first arm, and a second arm, said body made of a resilient material;
a first massage node mounted inside said body at said middle section, said first node having a rounded tip and adapted to deliver force to a user's neck when said middle portion is positioned in contact with said user's neck;
a second massage node mounted inside said body at said middle section, said second node having a rounded tip and adapted to deliver force to a user's neck when said middle portion is positioned in contact with said user's neck;
an electric motor; and
a gear drive system in mechanical communication with said motor to cause said nodes to rotate when activated by said user.

2. A neck massaging appliance according to claim 1, wherein
each said node has a generally symmetrical dome shaped tip.

3. A neck massaging appliance according to claim 1, wherein
each said node has a generally asymmetrical cone shaped tip.

4. A neck massaging appliance according to claim 1, wherein
each said node is mounted to a spring.

5. A neck massaging appliance according to claim 1, wherein
said motor is operable between an off condition and two separate operating speeds that cause said nodes to rotate together at the two separate speeds, respectively.

6. A neck massaging appliance according to claim 1, further comprising
a downwardly extending portion of said middle section, said nodes being located inside said downwardly extending portion.
